(19) United States
(12) Patent Application Publication
(10) Pub. No.: US 2009/0106319 A1
(43) Pub. Date: Apr. 23, 2009

(54) DATA MANAGEMENT APPARATUS AND DATA MANAGEMENT METHOD

(75) Inventors: Kazuhiro Ogura, Kanagawa-ken (JP); Shinji Makishima, Tokyo (JP); Akihiro Mizutani, Tokyo (JP); Toshihiro Ida, Tokyo (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/876,157

(22) Filed: Oct. 22, 2007

(51) Int. Cl. G06F 17/30

(52) U.S. Cl. 707/200; 707/E17.005

(57) ABSTRACT

A technique that improves convenience in accessing data stored in a predetermined memory area is provided.

An apparatus includes a storage processing unit 101 configured to store data into a predetermined memory area, an information acquiring unit 102 configured to acquire access information to access the data stored in the memory area by the storage processing unit 101, and an information output unit 103 configured to output the access information acquired by the information acquiring unit 102 to a predetermined recording medium in accordance with execution of data storage processing to the memory area by the storage processing unit 101.

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The present invention relates to management of data stored in a predetermined memory area, and particularly relates to a technique that improves convenience in accessing to the data stored in the memory area.

2. Description of the Related Art

Traditionally, there is known a technique of accumulating image data read from an original by an image reading device into a predetermined memory area of a server or the like.

With respect to the traditional technique, various techniques to handle data accumulated in the server or the like are disclosed (see JP-A-2004-64514, JP-A-2001-313913, and JP-A-2002-354164). However, as the volume of image data scanned by the image reading device and accumulated in the server or the like increases, it becomes difficult to search for the data which the user has saved himself.

Traditionally, in the case where the volume of data accumulated in the server or the like increases as described above, measures are taken such as deliberately designating the place to save data in or appending the date to each file name and using it as a reference. However, because of the large volume of data, again, it is difficult to accurately and quickly find image data which the user has scanned.

For the same reason, also in the case where the user wants to hand image data which the user has scanned, to another person, a deliberately designated file name must be sent to the person by e-mail.

In order to solve the above problems, it is an object of the present invention to provide a technique that improves convenience in access to data stored in a predetermined memory area.

### BRIEF DESCRIPTION OF THE DRAWINGS

FIG. 1 is a functional block diagram for explaining a data management apparatus according to the present embodiment and a network configuration including the data management apparatus.

FIG. 2 is a view showing a data structure of data managed in a data management server 4.

FIG. 3 is a view showing an example of data including access information sent from a communication device 103 to a communication terminal 3.

FIG. 4 is a flowchart for explaining a flow of processing in a data management method according to the present embodiment.

FIG. 5 shows an example of a screen display that gives an instruction to hold the communication terminal 3 over the communication device 103.

FIG. 6 is a flowchart for explaining a flow of processing in the data management method according to the present embodiment.

FIG. 7 is a flowchart for explaining a flow of processing in the data management method according to the present embodiment.

FIG. 8 is a flowchart for explaining a flow of processing in the data management method according to the present embodiment.

FIG. 9 is a flowchart for explaining a flow of processing in the data management method according to the present embodiment.

FIG. 10 is a flowchart for explaining a schematic flow of processing (data management method) in the data management apparatus according to the present embodiment.

### DETAILED DESCRIPTION OF THE INVENTION

Hereinafter, embodiments of the present invention will be described with reference to the drawings.

Throughout this description, the embodiments and examples shown should be considered as exemplars, rather than limitations on the apparatus, methods and programs of the present invention.

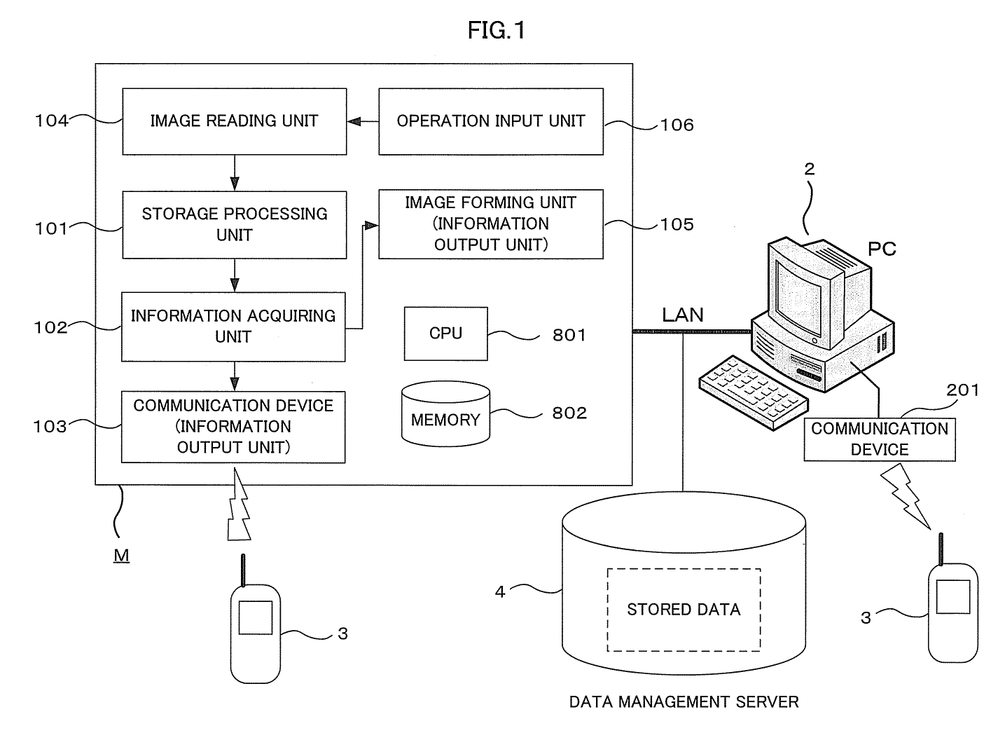

FIG. 1 is a functional block diagram for explaining a data management apparatus according to this embodiment and a network configuration including the data management apparatus. The network includes a data management apparatus M, a PC 2, a communication terminal 3, and a data management server 4.

The data management apparatus M according to the embodiment is, for example, an MFP (multi-function peripheral) and can communicate with the PC (personal computer) 2 that is connected with the data management apparatus M in a way that enables communication via a telecommunication line such as LAN. Also, the PC 2 and the data management server 4 can communicate with each other via a telecommunication line such as LAN.

In the data management apparatus M, an image of an original can be read in accordance with the user's operation input. The image of the original read in the data management apparatus M is converted into data and sent to the data management server 4.

Various data such as image data, document data and program files are stored in the data management server 4. These data are managed by the data management server 4.

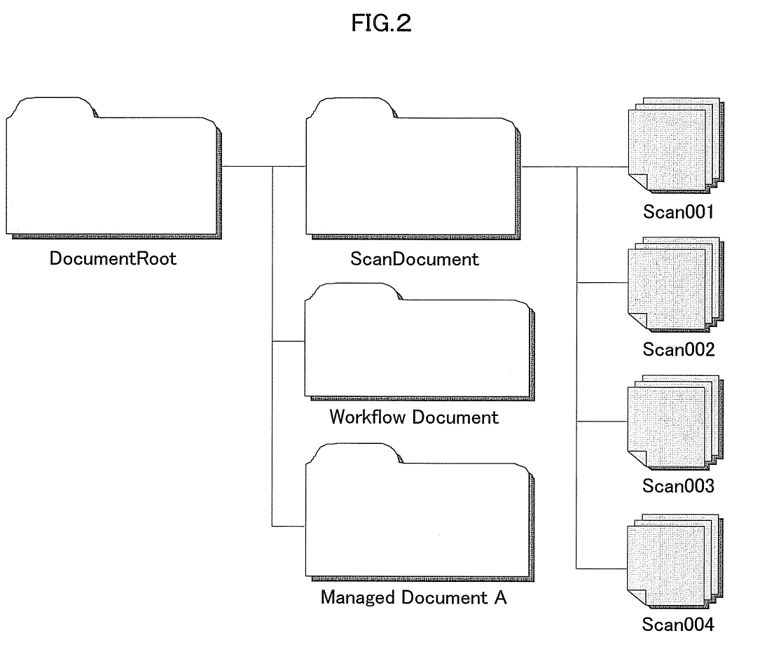

FIG. 2 is a view showing a data structure of data managed by the data management server 4. In this embodiment, document data is managed in a specific folder within a memory area of the data management server 4, using an ordinary server device. Of course, a document management system or the like can also be used for management of the document data.

In the memory area of the data management server 4, a “Document Root” folder for data management is prepared. In this folder, a “Scan Document” folder (predetermined memory area) for storing scanned document data is prepared along with “Workflow Document” and “Managed Document A” folders and so on. In the “Scan Document” folder, image data and the like of a document scanned from the original in the data management apparatus M is stored. In FIG. 2, an example is shown in which four data “Scan001”, “Scan002”, “Scan003” and “Scan004” are managed in the “Scan Document” folder.

In the PC 2, the data stored in the data management server 4 can be downloaded and displayed on the screen in accordance with the user's operation input. The PC 2 has a communication device 201 that can communicate with the communication terminal 3 (here, it is assumed to be a portable telephone) having a non-contact IC card (predetermined recording medium). The PC 2 can read data from the non-contact IC card provided in the communication terminal 3.

Next, the details of the configuration of the data management apparatus M will be described.

The data management apparatus M according to the embodiment has a configuration including a storage processing unit 101, an information acquiring unit 102, the communication device 103, an image reading unit 104, an image forming unit 105, an operation input unit 106, a CPU 801, and a memory 802.

First, the operation input unit 106 includes a keyboard, a mouse and the like. It is responsible for accepting an operation input from the user. Specifically, in this embodiment, the operation input unit 106 is realized by a touch display panel, not shown, provided in the data management apparatus M.

The image reading unit (image reading means) 104 reads an image of an original when the operation input unit 106 has accepted an operation input to instruct start of image reading from the user, or when an instruction to start image reading is given from the PC 2 via the LAN.

The storage processing unit (storage processing means) 101 causes the image data read by the image reading unit 104 to be stored into the “Scan Document” folder (predetermined memory area) in the data management server 4. The data stored into the data management server 4 by the storage processing unit 101 is not necessarily limited to the very data that is scanned by the image reading unit 104, but it may be data sent to the data management server 4 via the data management apparatus M, or data to which image processing has been performed after scanning in the data management apparatus M, and so on.

The information acquiring unit (information acquiring means) 102 acquires access information to access the data stored in the memory area in the storage processing unit 101. The “access information” mentioned here is specifically, for example, ID information (identification information) of the data in the data management server 4, or information indicating the location of the data stored in the memory area such as URL or a path indicating the data storage location. The information acquiring unit 102, for example, communicates with the data management server 4 and thereby acquires the access information.

The communication device (information output unit, information output means) 103 includes a data writing device capable of writing data to a non-contact IC card. In accordance with execution of data storage processing to the “Scan Document” folder by the storage processing unit 101, the communication device 103 writes the access information acquired by the information acquiring unit 102 to the non-contact IC card (predetermined recording medium) provided in the communication terminal 3 held closely to the communication device 103.

Here, in this example, the predetermined recording medium is a non-contact IC card. However, the predetermined recording medium is not limited to this, and portable memory media such as flexible disk, CD-R, USB memory, non-contact IC card, magnetic card, electronic receipt, and RFID can be employed. Also, as a data writing system by the data writing device, the Near Field Communication Standard (NFC), ToruCa (trademark registered), Bluetooth (trademark registered), IrDA (trademark registered) and the like can be employed.

In the case of using an electronic receipt, non-contact IC card, magnetic card and RFID repeatedly, it is preferable to erase already written information and then reuse them.

Meanwhile, the recording medium to be a target of writing the access information need not necessarily be provided within the communication terminal. It may be a separate recording medium which enables data writing and data reading.

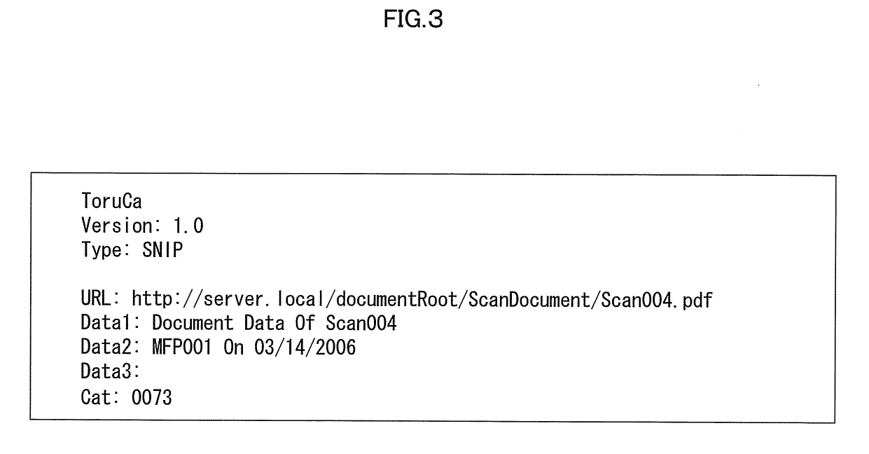

FIG. 3 is a view showing an example of data including access information sent from the communication device 103 to the communication terminal 3. The data shown in FIG. 3 includes “URL”, “document name”, “date and time of scan execution” and the like of the document data scanned by the image reading unit 104 in the data management apparatus M and stored in the data management server 4.

The communication device 103 also causes the access information to be outputted to the predetermined recording medium during a period at least from the start of execution of the data storage processing to the data management server 4 by the storage processing unit 101 until a predetermined time (for example, about 30 seconds) after the completion of the data storage processing. As the access information of the data can be thus made accessible substantially in the same timing as the timing of carrying out data storage processing to the data management server 4 in the data management apparatus M, the user is enabled to intuitively recognize that it is the access information of the data stored in the data management server 4 in certain timing.

In the case where the volume of data to be stored by the storage processing unit 101 is a predetermined value or more, the communication device 103 can also output the access information before the completion of the data storage processing by the storage processing unit 101. Thus, in the case where the volume of data to be stored in the data storage area is so large that the data storage processing (data writing processing to the memory area) itself takes extremely long time, the user can be quickly notified of the access information without wasting time by waiting.

Also, in the above example, the configuration is described in which access information of data is stored as data into a recording medium such as a memory. However, the configuration is not limited to this. The access information may be printed on a print sheet (predetermined recording medium) by the image forming unit 105. As the print sheet here, for example, a copy paper (so-called normal paper), plastic film or the like can be employed.

The CPU 801 is responsible for carrying out various processings in the data management apparatus and is also responsible for realizing various functions by executing programs stored in the memory 802. The memory 802 includes, for example, a ROM or RAM and is responsible for storing various information and programs used in the data management apparatus M.

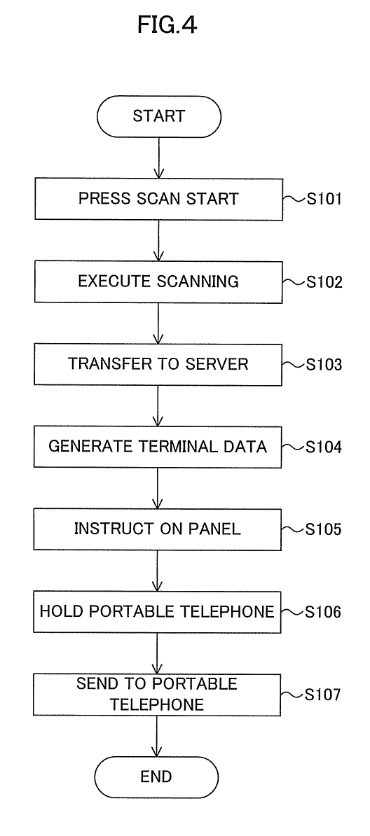

FIG. 4 and FIGS. 6 to 9 are flowcharts for explaining flows of processing in a data management method according to this embodiment.

FIG. 4 is a flowchart showing a flow of processing in the data management apparatus M.

As the operation input unit 106 accepts an instruction to start scanning from the user (S101), image reading processing of an original in the image reading unit 104 is started (S102).

After the completion of the image reading processing in the image reading unit 104, the read image data is sent to the data management server 4 by the storage processing unit 101 (S103). Here, the storage processing unit 101 appends a file name to the data when storing the data into the data management server 4.

The information acquiring unit 102 acquires the appended file name (access information) and generates data to be transferred to the communication terminal 3 on the basis of the file name (S104).

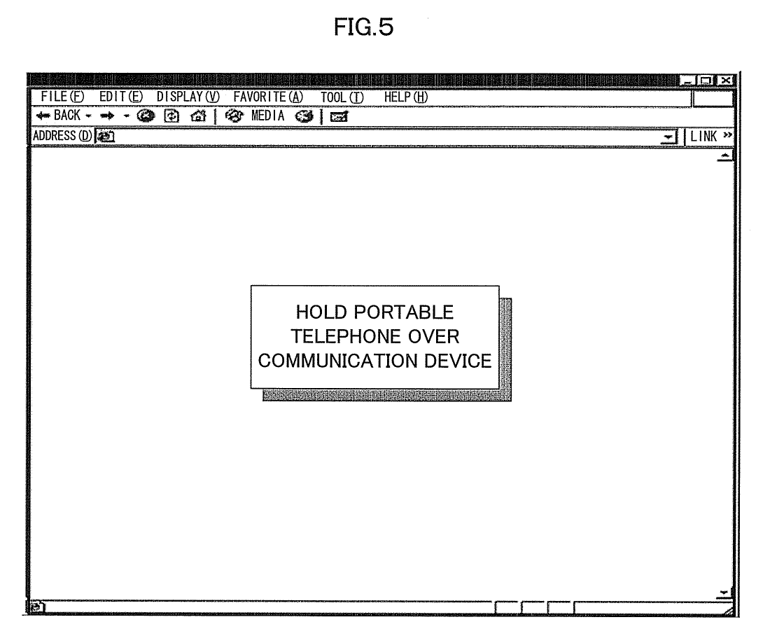

Next, as shown in FIG. 5, an instruction to hold the communication terminal 3 over the communication device 103 is displayed on the screen of a touch panel display, not shown (S105).

After that, when the user holds the communication terminal 3 over the communication device 103 (S106), the data for transfer is written to the recording medium of the communication terminal 3 by the communication device 103 (S107).

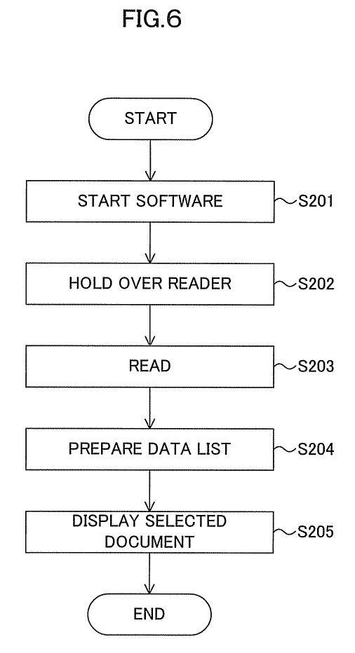

FIG. 6 is a flowchart for explaining a flow of processing in the PC 2.

First, application software to display on the screen the data stored in the data management server 4 is started on the PC 2 (S201).

Next, the user holds the communication terminal 3 over the communication device 201 of the PC 2 (S202).

The communication device 201 reads all the data stored in the recording medium of the communication terminal 3 (S203).

The PC 2 prepares a list of the data acquired from the communication terminal 3 via the communication device 201 (S204) and displays data which the user has arbitrarily selected from the data list, on the screen (S205).

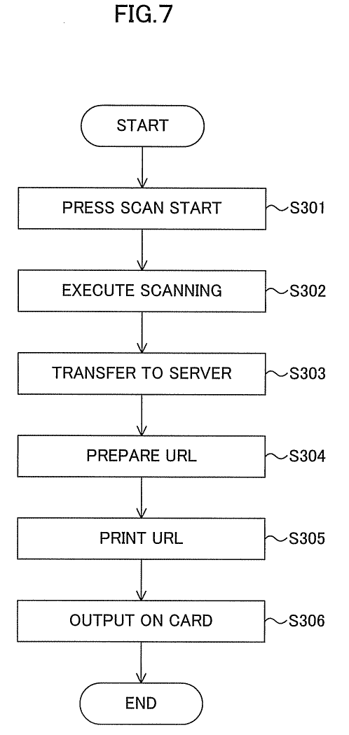

FIG. 7 is a flowchart showing another example of processing in the data management apparatus M.

As the operation input unit 106 accepts an instruction to start scanning from the user (S301), image reading processing of an original in the image reading unit 104 is started (S302).

After the completion of the image reading processing in the image reading unit 104, the read image data is sent to the data management server 4 by the storage processing unit 101 (S303). Here, the storage processing unit 101 appends a file name to the data when storing the data into the data management server 4.

The information acquiring unit 102 acquires the appended file name (access information) and generates URL to access the data having this file name on the basis of the file name (S304).

Next, the URL generated as described above is printed on a sheet by the image forming unit 105 (S305) and outputted (S306). The print processing of the URL data onto the sheet here is carried out, for example, by printing it as a two-dimensional bar code. However, though an example of printing the URL data as a two-dimensional bar code is given, the printing is not limited to this. The file number or the character string of the URL may be printed as it is. Also, the URL data can be written as data to the recording medium of the communication terminal 3.

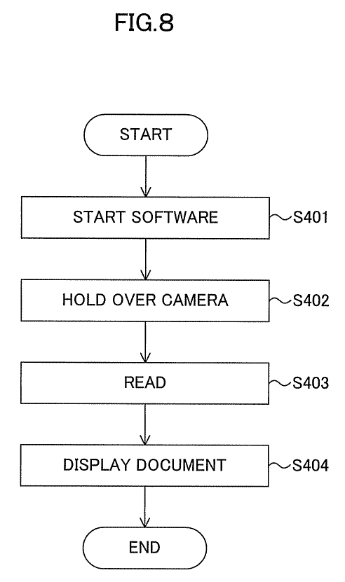

FIG. 8 is a flowchart for explaining another example of processing in the PC 2. Here, the processing is carried out on the assumption that the communication device 201 has an image pickup device.

First, an application to display on the screen the data stored in the data management server 4 is started on the PC 2 (S401).

Next, the card on which the access information has been printed in the processing shown in FIG. 7 is held over the image pickup device of the communication device 201 of the PC 2 (S402).

The communication device 201 reads the access information (or the bar code or the like generated on the basis of the access information) printed on the card (S403).

The PC 2 acquires the URL of the data for which the access information is read from the card via the communication device 201, and displays the data on the screen (S404).

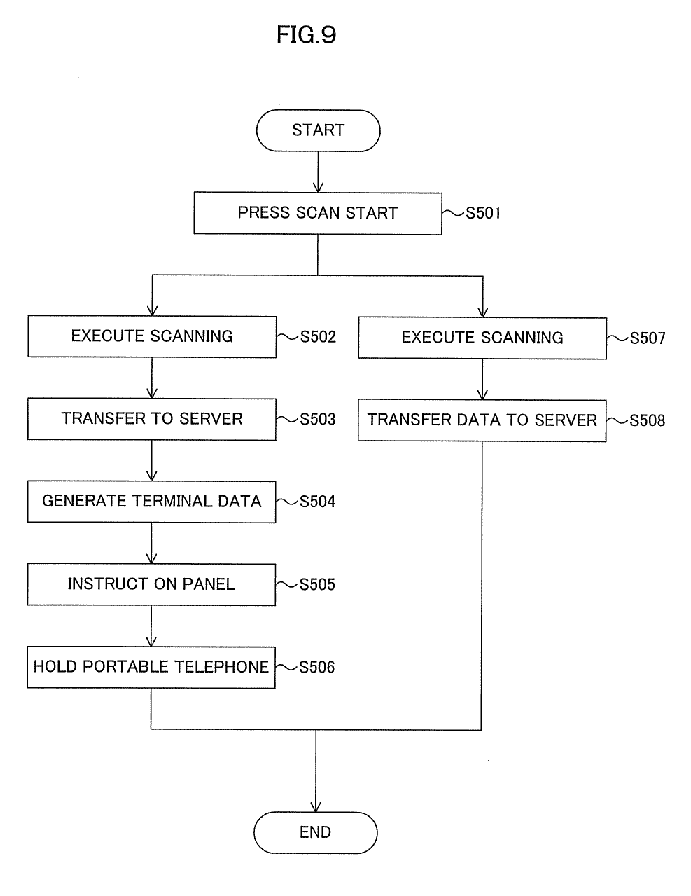

FIG. 9 is a flowchart showing still another example of processing in the data management apparatus M.

As the operation input unit 106 accepts an instruction to start scanning from the user (S501), image reading processing of an original in the image reading unit 104 is started (S502).

After the completion of the image reading processing in the image reading unit 104, the read image data is sent to the data management server 4 by the storage processing unit 101 (S503).

The information acquiring unit 102 acquires the access information of the data sent to the data management server 4 and generates data to be transferred to the communication terminal 3 on the basis of the access information (S504).

Next, as shown in FIG. 5, an instruction to hold the communication terminal 3 over the communication device 103 is displayed on the screen of a touch panel display, not shown (S505). After that, when the user holds the communication terminal 3 over the communication device 103 (S506), the data for transfer is written to the recording medium of the communication terminal 3 by the communication device 103.

Meanwhile, in the case where the volume of data to be stored by the storage processing unit 101 is a predetermined value or more (for example, 40 MB or more), the communication device 103 executes scanning processing before the completion of the data storage processing by the storage processing unit 101 (S507), and then outputs the access information to the communication terminal 3 parallel to the transfer of the scanned data to the data management server 4 (S508).

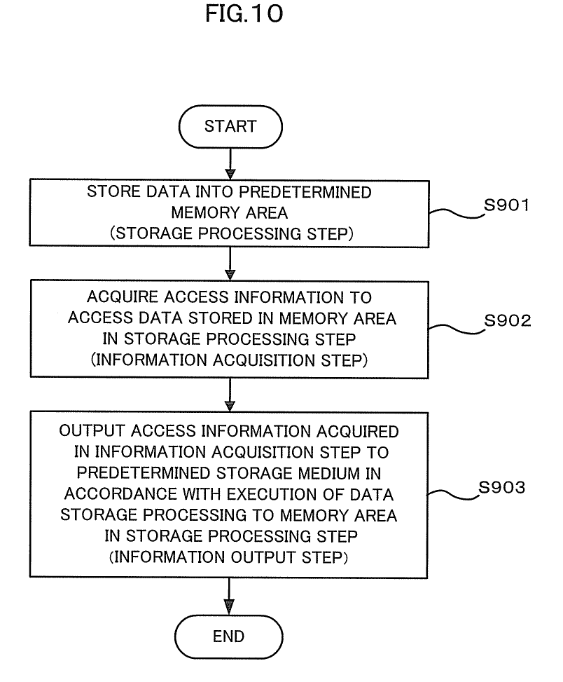

FIG. 10 is a flowchart for explaining a schematic processing flow (data management method) in the data management apparatus according to this embodiment.

The storage processing unit 101 stores the data into a predetermined memory area (storage processing step) (S901).

The information acquiring unit 102 acquires access information to access the data stored in the memory area in the storage processing step (information acquisition step) (S902).

The information output unit 103 outputs the access information acquired in the information acquisition step to a predetermined recording medium in accordance with execution of data storage processing to the memory area in the storage processing step (information output step) (S903). Here, in the information output step, it is preferred that the access information is outputted to the predetermined recording medium during a period from the start of execution of the data storage processing to the memory area in the storage processing step until a predetermined time after the completion of the data storage processing.

Each step of the processing in the above data management apparatus is realized as the data management program stored in the memory 802 is executed by the CPU 801.

In this embodiment, the case where the function to carry out the invention has been recorded in advance in the apparatus is described. However, it is not limited to this. The similar function may be downloaded from a network to the apparatus, or a recording medium storing the similar function may be installed in the apparatus. As a recording medium, any form of recording medium that can store a program and can be read by the apparatus, such as a CD-ROM, can be employed. Also, the functions that can be acquired by being installed or downloaded in advance may be realized in cooperation with the OS (operating system) and the like in the apparatus.

As described above, according to this embodiment, the user can accurately and easily access document data which the user himself has scanned. Also, in the case where the user wants to provide document data or the like which the user himself has scanned, to an arbitrary counterpart, the user can provide data securely and safely to the counterpart, for example, by handing a card or the like on which the access information of the document data has been recorded.

The specific embodiment of the invention has been described in detail. However, it is obvious to a person skilled in the art that various changes and modifications can be made without departing from the spirit and scope of the invention.

As described above in detail, according to the present invention, a technique that improves convenience in accessing data stored in a predetermined memory area can be provided.

What is claimed is:

1. A data management apparatus comprising:
a storage processing unit configured to store data into a predetermined memory area;
an information acquiring unit configured to acquire access information to access the data stored in the memory area by the storage processing unit; and
an information output unit configured to output the access information acquired by the information acquiring unit to a predetermined recording medium in accordance with execution of data storage processing to the memory area by the storage processing unit.

2. The data management apparatus according to claim 1, comprising an image reading unit configured to read an image of an original,
wherein the storage processing unit stores image data read by the image reading unit to a predetermined memory area.

3. The data management apparatus according to claim 1, wherein the information output unit outputs the access information to a predetermined recording medium during a period from start of execution of data storage processing to the memory area by the storage processing unit until a predetermined time after completion of the data storage processing.

4. The data management apparatus according to claim 1, wherein the information output unit carries out output of the access information before completion of data storage processing by the storage processing unit in the case where a volume of data to be stored by the storage processing unit is a predetermined value or more.

5. The data management apparatus according to claim 1, wherein the predetermined recording medium is a portable storage medium, and
the information output unit is a data writing device capable of writing data to the portable storage medium.

6. The data management apparatus according to claim 1, wherein the predetermined recording medium is a print sheet, and
the information output unit is an image forming device capable of forming an image on the print sheet.

7. The data management apparatus according to claim 1, wherein the access information is ID information.

8. The data management apparatus according to claim 1, wherein the access information is information indicating location.

9. The data management apparatus according to claim 1, wherein the access information is a URL or a path indicating a data storage location.

10. The data management apparatus according to claim 1, wherein when storing data to the predetermined memory area, the storage processing unit appends a file name to the data, and
the access information is the file name appended by the storage processing unit.

11. A data management apparatus comprising:
storage processing means for storing data into a predetermined memory area;
information acquisition means for acquiring access information to access the data stored in the memory area by the storage processing means; and
information output means for outputting the access information acquired by the information acquisition means to a predetermined recording medium in accordance with execution of data storage processing to the memory area by the storage processing means.

12. A data management method comprising the steps of:
storing data into a predetermined memory area;
acquiring access information to access the data stored in the memory area in the step of storing the data; and
outputting the access information acquired in the step of acquiring the access information to a predetermined recording medium in accordance with execution of data storage processing to the memory area in the step of storing the data.

13. The data management method according to claim 12, wherein the step of outputting the access information includes outputting the access information to a predetermined recording medium during a period from start of execution of data storage processing to the memory area in the step of storing the data unit until a predetermined time after completion of the data storage processing.

14. The data management method according to claim 12, wherein the step of outputting the access information includes carrying out output of the access information before completion of data storage processing in the step of storing the data in the case where a volume of data to be stored in the step of storing the data is a predetermined value or more.

15. The data management method according to claim 12, wherein the predetermined recording medium is a portable storage medium, and
the step of outputting the access information includes writing the data to the portable storage medium.

16. The data management method according to claim 12, wherein the predetermined recording medium is a print sheet, and
the step of outputting the access information includes carrying out image forming processing to the print sheet.

17. The data management method according to claim 12, wherein the access information is ID information.

18. The data management method according to claim 12, wherein the access information is information indicating location.

19. The data management method according to claim 12, wherein the access information is a URL or a path indicating a data storage location.

20. The data management method according to claim 12, wherein the step of storing the data includes appending a file name to the data when storing the data to the predetermined memory area, and
the access information is the file name appended in the step of storing the data.
